(19) United States
(12) Patent Application Publication
(10) Pub. No.: US 2018/0268322 A1
(43) Pub. Date: Sep. 20, 2018

(54) Dynamic Parking Information Management System

(71) Applicant: Yafang Liu, Belmont, CA (US)

(72) Inventor: Yafang Liu, Belmont, CA (US)

(21) Appl. No.: 15/912,560

(22) Filed: Mar. 5, 2018

Related U.S. Application Data
(60) Provisional application No. 62/471,962, filed on Mar. 16, 2017.

(51) Int. Cl. G06Q 10/02; G06F 17/30; G06Q 20/32; G06Q 20/40; G06Q 20/36

(52) U.S. Cl. CPC G06Q 10/02; G06F 17/30864; G06Q 20/322; G08G 1/144; G06Q 20/36; G06Q 2240/00; G06Q 20/40145

(57) ABSTRACT

Systems, methods, devices and non-transitory, computer-readable storage mediums are disclosed for a dynamic parking information management system (DPIMS). DPIMS is a centralized, online aggregator of parking assets for a location of interest for real-time and scheduled parking requests. DPIMS dynamically updates parking asset inventory based on reports from providers of available parking assets, including commercial, private and flash parking asset providers. DPIMS also provides a mobile valet service for location-based, on-demand valet services that use the parking asset inventory provided by DPIMS servers.

### CROSS-RELATED APPLICATION

This application claims the benefit of priority from U.S. Provisional Application No. 62/471,962, filed Mar. 16, 2017, for “Dynamic Parking Information Management System,” which provisional patent application is incorporated by reference herein in its entirety.

### TECHNICAL FIELD

This disclosure relates generally to solutions for finding parking spaces for vehicles in urban and other environments.

### BACKGROUND

Virtually every car owner has experienced the pain of finding a parking space in dense urban environments or other densely populated areas, such as large parking lots or structures adjoining, sports venues, museums and amusement parks.

Some common solutions to the parking problem is public transportation, ride sharing, taxis or Uber® drivers and valet services. In many cases, however, none of these parking solutions are adequate. For example, there may not be public transportation available, strikes, outages or other problems that makes public transportation not an option. Ride sharing works well if the riders are leaving from the same location and traveling to the same destination. Taxis are notoriously difficult to hail in dense urban areas and are expensive. Uber® drivers are a convenient substitute for taxi service but suffer from the same problems as taxi services in terms of convenience and expense. Valet services are limited to specific businesses and parking structures that offer the service to patrons, which limits their usefulness for non-patrons.

### SUMMARY

Systems, methods, devices and non-transitory, computer-readable storage mediums are disclosed for a dynamic parking management system. The dynamic parking management system is a comprehensive online solution to the parking problem. The system includes three complimentary applications: dynamic parking asset inventory management; flash parking services; and mobile valet services.

Dynamic parking information management system (DPIMS) aggregates available parking spaces or spots (hereinafter also referred to as “parking assets”) from owners of parking assets (hereinafter also referred to as “parking asset providers). DPIMS is a database system that is continuously updated based on inputs from customers (hereafter referred to as “parking asset requestors”), parking asset providers, flash parking service providers and mobile valet service providers. Each of these provider classes can access DPIMS through a graphical user interface (GUI) specifically tailored to each class and the type and quantity of information need for the class. In an embodiment, each of the provider classes and the parking asset requestors subscribe to DPIMS. A website hosted by DPIMS can be accessed through a browser on a provider or requestor device. The website provides web pages that include dialogue for collecting user/subscriber information to set up user accounts. The user account information can include, but is not limited to: names, addresses, contact information and billing information for making and receiving payments online. The users/subscribers select usernames and passwords to allow access to their account pages on the website. The usernames and passwords are used to authenticate the users/subscribers before allowing access to their user accounts or services. In some embodiments, parking asset requestors (customers) need not set-up a user account before using DPIMS. Setting-up a user account, however, allows the parking asset requestor to provide credit card information for automatically paying service fees or depositing funds from which service fees can be paid.

The parking asset providers include commercial parking asset providers, private parking asset providers and flash parking asset providers. Commercial parking asset providers include any business or entity that provides parking assets as a business, including but not limited to parking structure or parking lot owners. Private providers are any individual that owns or leases a space that is of sufficient size to be used for parking, including but not limited to: homeowners (e.g., driveways, garages, and backyards), landowners, storage unit owners, apartment complexes, private businesses (e.g., hotels, theatres, retail stores, and companies), government agencies, museums, local and national park services, and entertainment or sports venues. Flash parking providers do not own or lease any parking spaces but rather provide a service of finding and reporting available public or metered parking spaces to DPIMS through their mobile devices. A typical flash parking provider can be a pedestrian who opportunistically finds available public parking assets and reports those spaces using a GUI provided by a DPIMS mobile application installed on their mobile device (e.g., smart phone, smart watch, tablet computer), and reports the available spaces to DPIMS.

Providers of the mobile valet service use DPIMS to provide valet services at any location requested by a requestor. The provider of mobile valet services will be given access to a list of mobile value service requests and the drop-off location where the service will begin. The mobile valet service provider will meet the requestor at an agreed upon drop-off location, and for an agreed upon price, will take possession of the requestor's vehicle and park the vehicle with the help of DPIMS. At another agreed upon time, the mobile valet service provider will meet the requestor at an agreed upon pick-up location to regain possession of their vehicle. By using DPIMS, the mobile valet service provider will more easily find available parking near the pick-up location. In an embodiment, DPIMS will require additional information from mobile valet service providers to ensure they are qualified to drive, including but not limited to: a valid driver's license, proof of active insurance and a criminal background check.

Particular embodiments disclosed herein provide one or more of the following advantages. The disclosed embodiments provide a centralized online parking information management system that aggregates and dynamically updates available parking spaces for any desired location of interest. DPIMS receives as inputs parking asset information from a variety of sources, including non-traditional sources such as homeowners and pedestrians, which represent a massive untapped inventory of parking spaces. DPIMS provides a mobile valet service for on-demand, location-based valet services to users/subscribers of DPIMS. By maintaining a comprehensive, real-time parking asset inventory database in centralized, online service, users/subscribers have a variety of convenient applications for solving their parking problems in dense urban environments and other locations where parking spaces are scarce or not conveniently located.

The disclosed embodiments also provide the appropriate incentives for each player in the system to encourage providing input into the inventory database. For example, flash parking asset providers (e.g., pedestrians) receive a payment for each available public parking space they report to DPIMS that is verified and occupied by a requestor. This incentive creates an army of people who are incentivized to contribute parking assets to DPIMS.

Private parking asset providers (e.g., homeowners, storage unit owners, landowners, businesses) often know when they will be staying home and often have an empty driveway or garage that they can let someone temporarily use and make a profit from by simply interacting with a DPIMS website with dates of availability. Users/subscribers can make a reservation to reserve the parking asset through DPIMS with little effort by either party.

Commercial parking asset providers (e.g., businesses, government entities) have the same incentives as homeowners but often have many empty employee parking spaces during high demand times like Friday and Saturday nights. DPIMS provides these businesses and government entities with additional sources of revenue without expending capital or human resources.

The mobile valet service provides much needed employment opportunities to anyone with a license to drive. Businesses that cannot afford their own valet services can receive the benefits of valet service by using the mobile valet service. The mobile valet service has an advantage in that it has exclusive use of DPIMS to find suitable parking assets for valet parking.

The details of the disclosed embodiments are set forth in the accompanying drawings and the description below. Other features, objects and advantages are apparent from the description, drawings and claims.

DESCRIPTION OF DRAWINGS

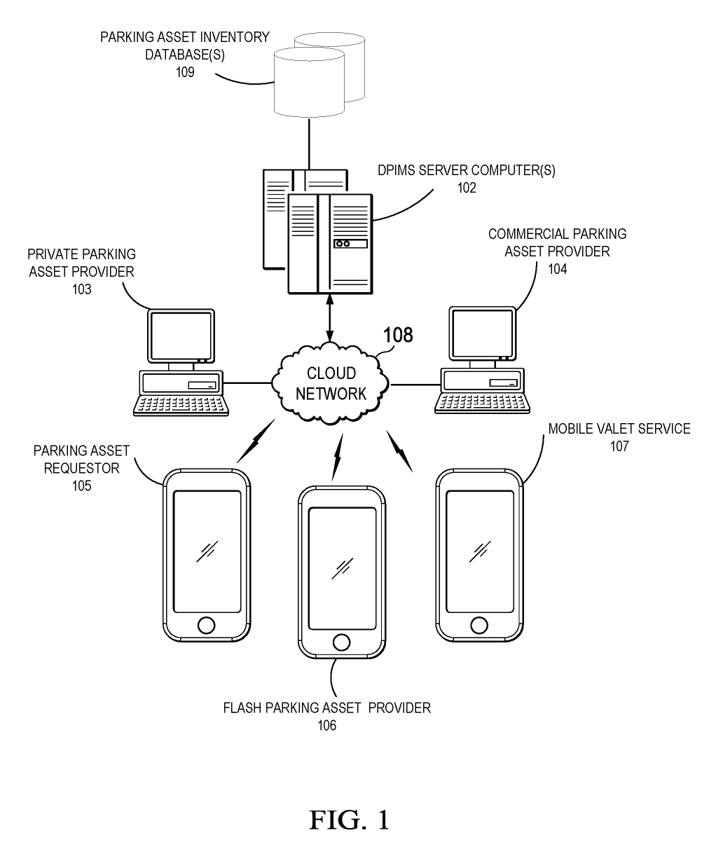

FIG. 1 is a block diagram of a dynamic parking information management system (DPIMS), according to an embodiment.

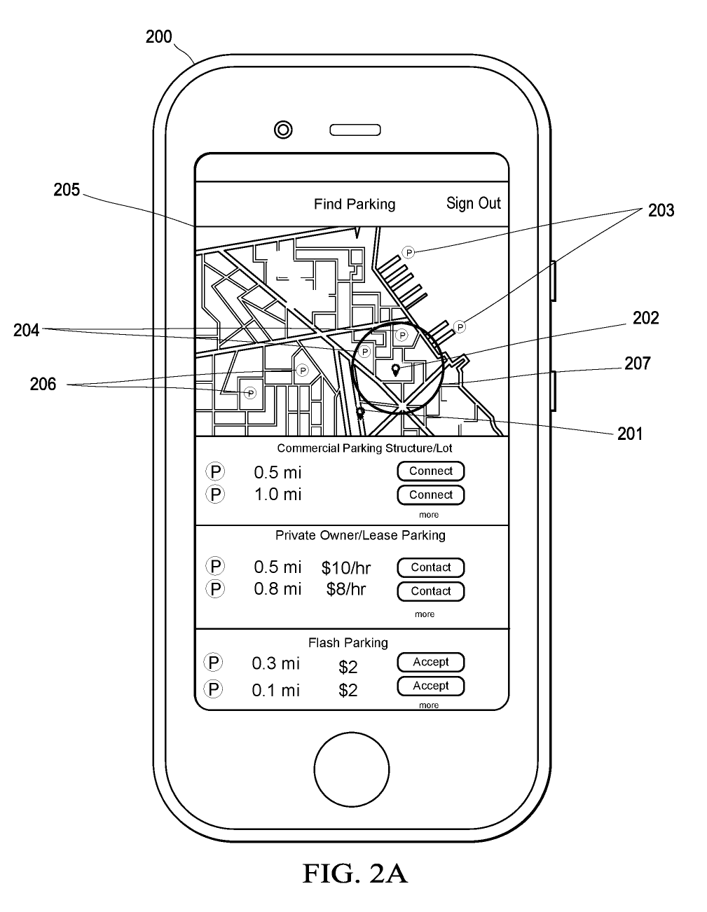

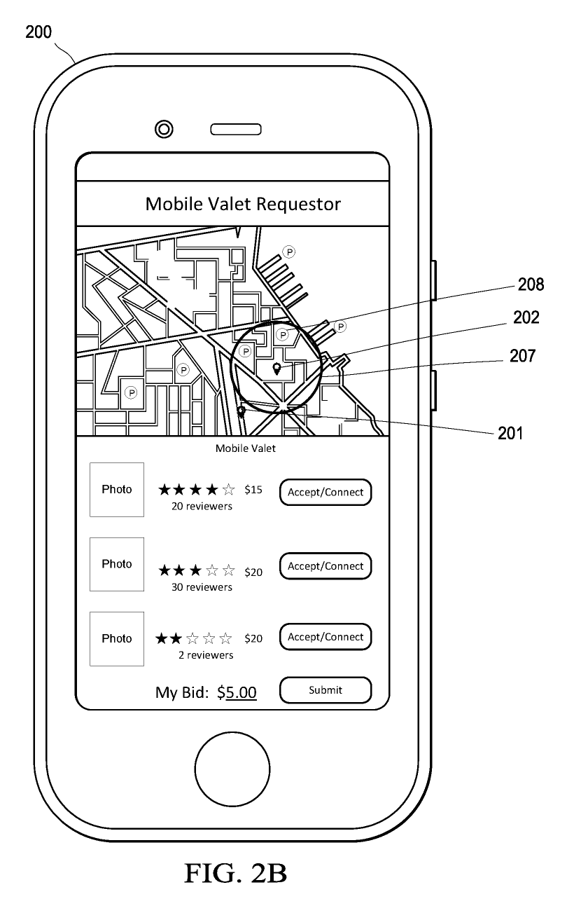

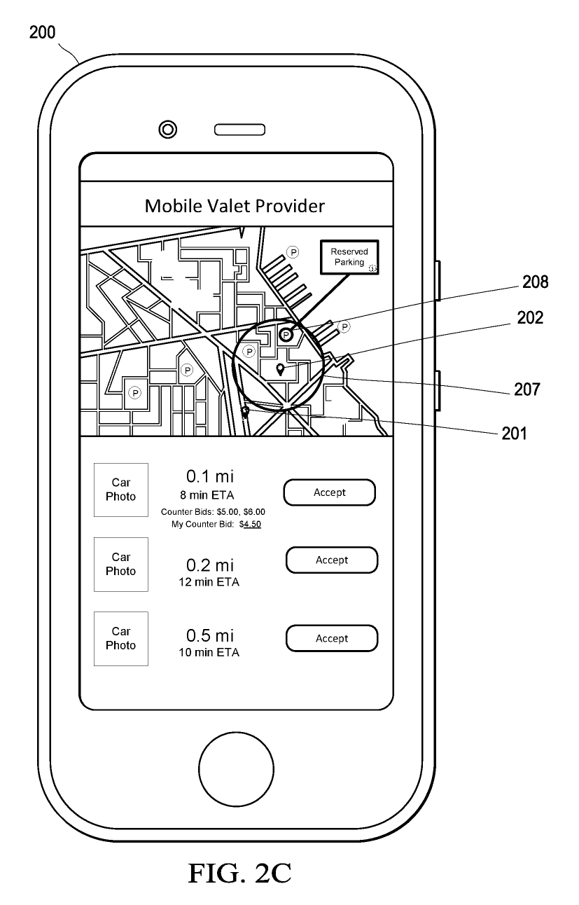

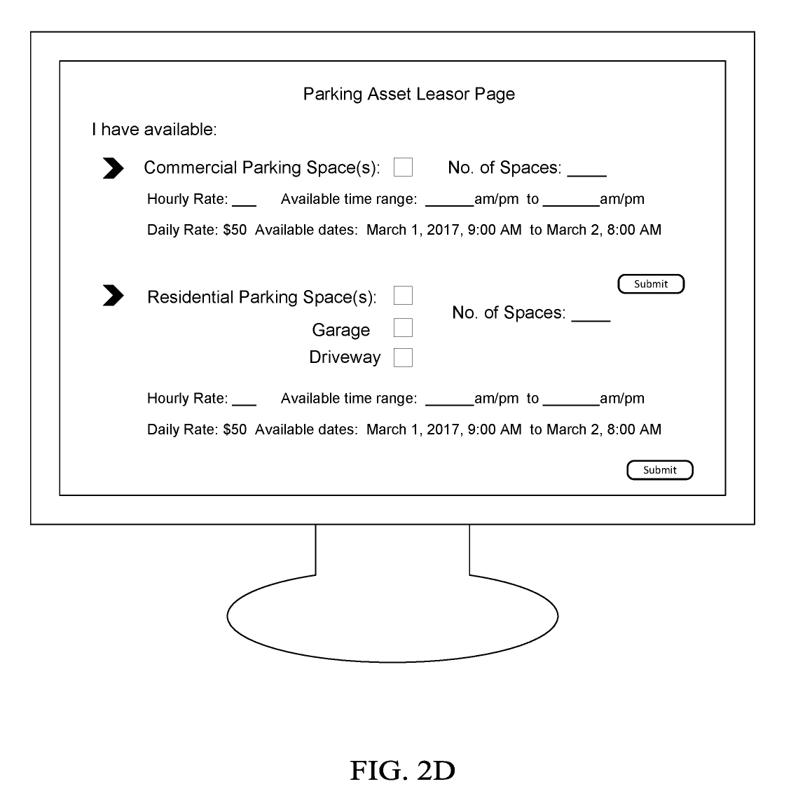

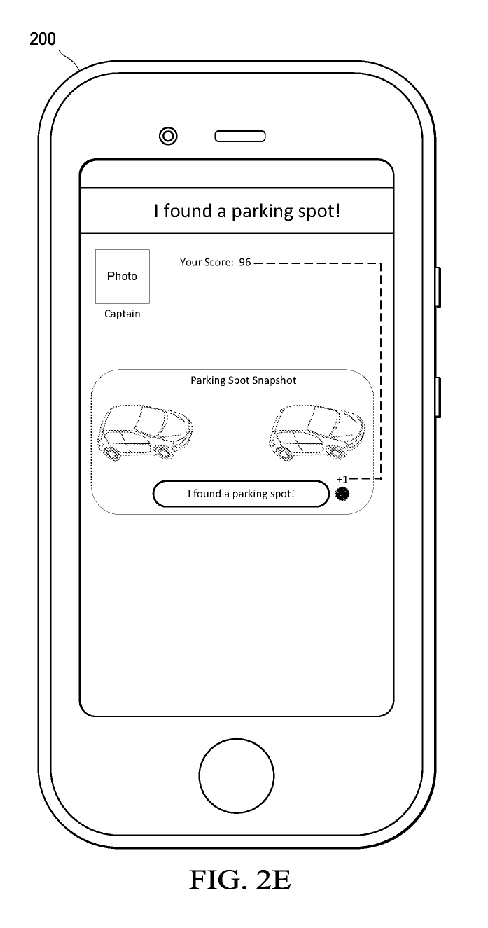

FIG. 2A is an example GUI for a mobile device that is provided to a requestor, according to an embodiment.

FIG. 2B is an example GUI for a mobile device that is provided to requestor for mobile valet services, according to an embodiment.

FIG. 2C is an example GUI for a mobile device that is provided to a mobile valet service provider, according to an embodiment.

FIG. 2D is an example webpage for a parking asset lessor, according to an embodiment.

FIG. 2E is an example GUI for a mobile device provided to a requestor verifying a flash parking asset through a digital photo, according to an embodiment.

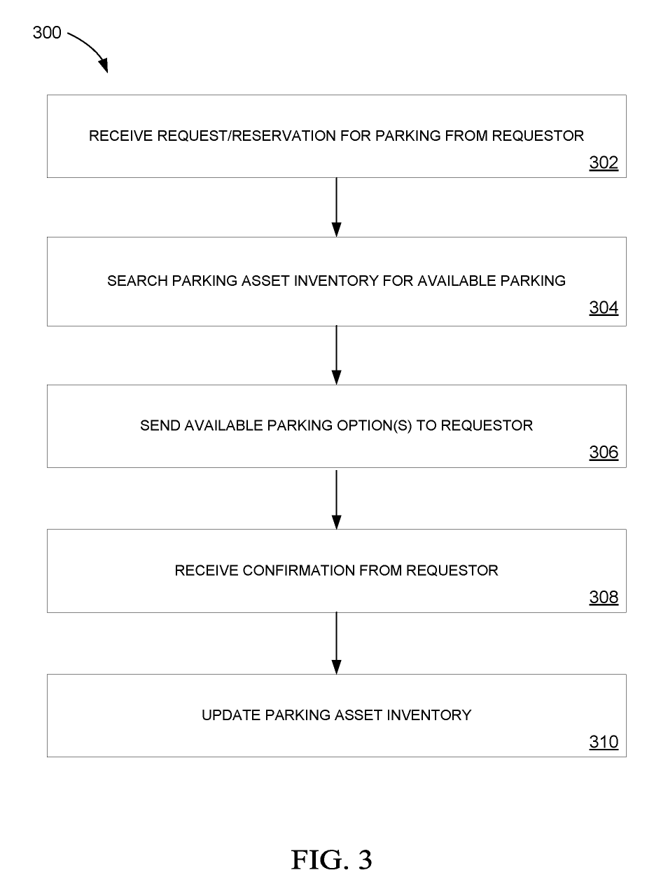

FIG. 3 is a flow diagram of a DPIMS process, according to an embodiment.

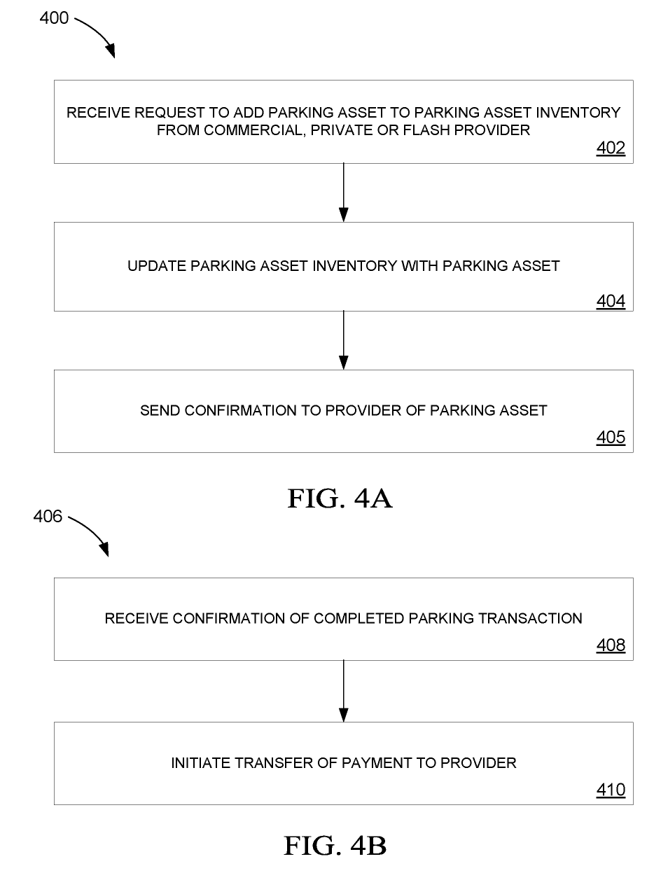

FIG. 4A is a flow diagram of a DPIMS process for receiving reports from parking asset providers of available parking assets, according to an embodiment.

FIG. 4B is a flow diagram of a DPIMS process for making payments to parking asset providers upon completion of a parking transaction, according to an embodiment.

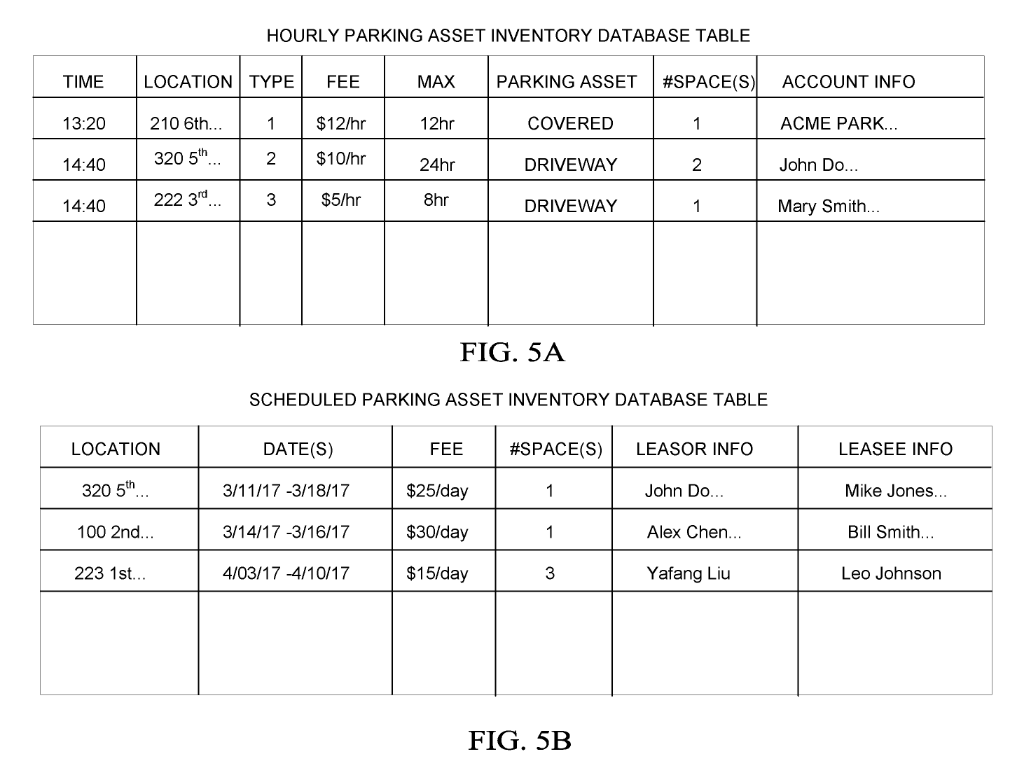

FIG. 5A illustrates database table record for hourly parking asset inventory, according to an embodiment.

FIG. 5B illustrates database table record for scheduled parking asset inventory, according to an embodiment.

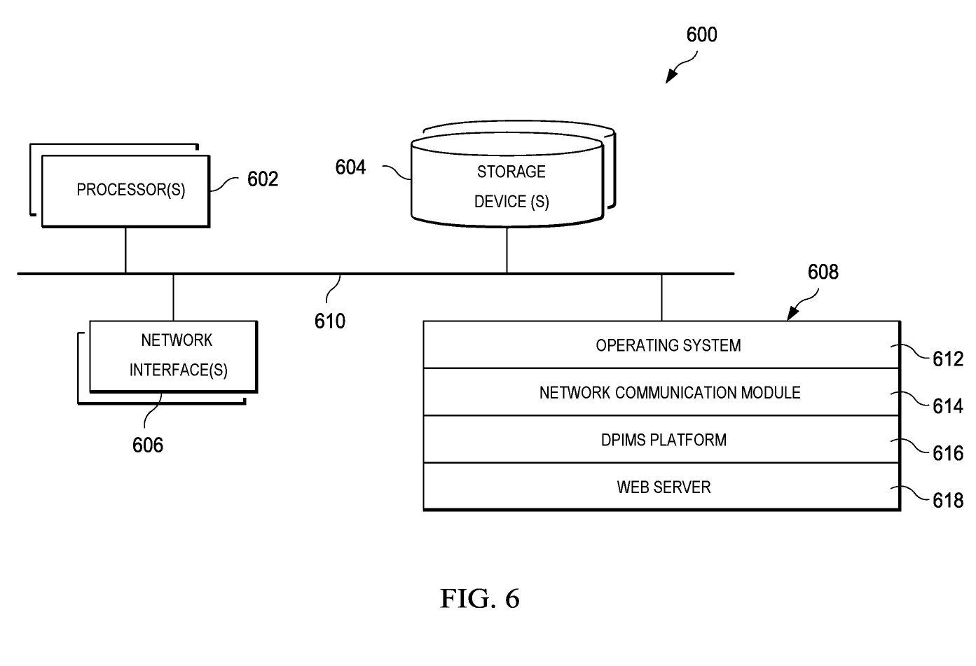

FIG. 6 is a DPIMS server computer architecture, according to an embodiment.

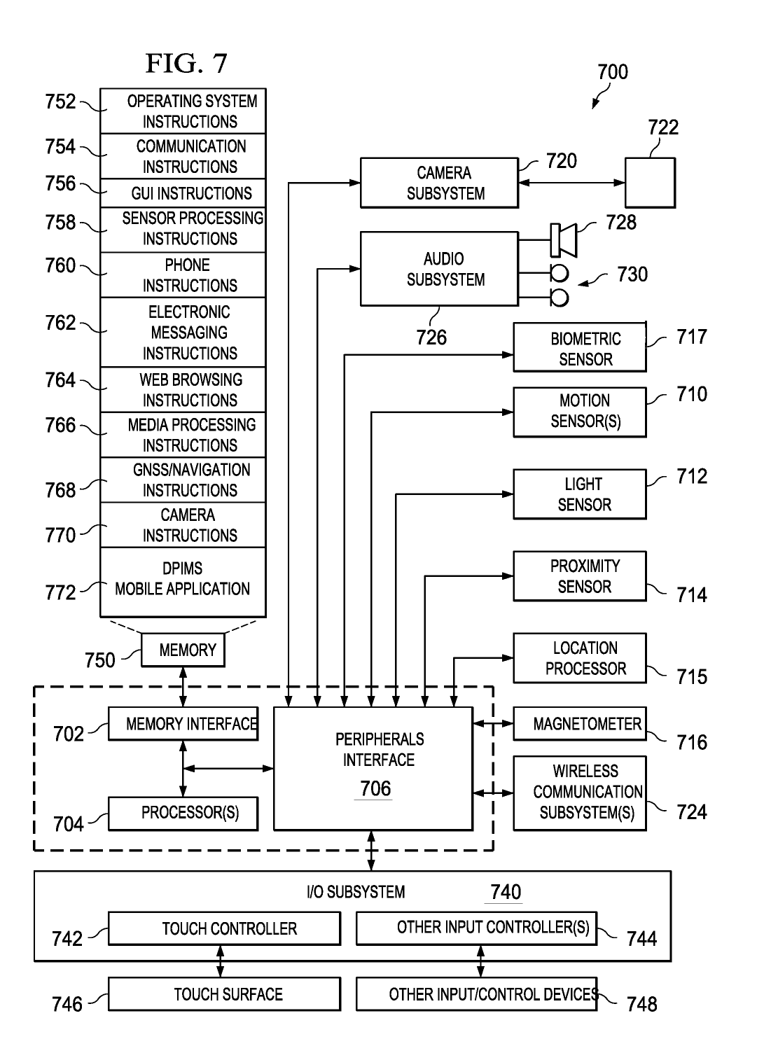

FIG. 7 is an electronic device architecture for electronic devices used by requestors and providers of parking assets, according to an embodiment.

The same reference symbol used in various drawings indicates like elements.

### DETAILED DESCRIPTION

### Example System

FIG. 1 is a block diagram of a dynamic parking information management system (DPIMS) 100, according to an embodiment. DPIMS 100 includes DPIMS server computer(s) 102, private parking asset providers 103, commercial parking asset provider 104, parking asset requestor 105, flash parking asset provider 106, mobile valet service and provider 107. Each of these entities of DPIMS 100 communicate with DPIMS server computers 102 through cloud network 108 (e.g., Internet) using one or more communication protocols (e.g., TCP/IP, HTTP). DPIMS server(s) 102 are coupled parking asset inventory databases 109, which store data records of parking assets.

Each of the entities of DPIMS 100 operate electronic devices to interact with DPIMS server(s), including but not limited to: desktop computers, notebook computers, tablet computers, wearable computers and smartphones. Cloud network 108 can include any number and kind of wired or wireless networks, including but not limited to any configurations of wide area networks (WANs) and local area networks (LANs). Cloud network 108 can include both public and private networks. DPIMS 100 can include any number of server computers 102, databases 109, and any number or type of provider devices 103, 104, 106, 107 and requestor devices 105.

In an embodiment, DPIMS 102 server computer(s) host a website that provides webpages and GUIs to the various DPIMS entities to facilitate communication with DPIMS server computer(s) 102, as described in reference to FIGS. 2A-2E. For example, private parking asset providers can log into a user account to add private parking assets to the parking asset inventory database(s) 109. Such private parking assets can include driveways, garages, backyards, vacant lots, storage units and the like. Similarly, commercial parking asset providers 104 can log into a user account and add commercial parking assets to parking asset inventory database(s) 109, such as parking structures, parking lots, storage units and the like.

Parking asset requestors 105 who are in immediate need of a parking asset, would like to reserve a parking asset for a future date or time or order mobile valet service, can make a request or reservation for these services through a website user account or directly from a DPIMS mobile client application running on their mobile device. Flash parking asset provider 106 (e.g., pedestrians) can report through the DPIMS mobile client application available parking assets that they come upon and receive payment for each report that is verified (e.g., taking a digital photograph of the available parking asset using their mobile device camera), and in which a parking transaction has successfully been completed. A “parking transaction” is successfully completed when a requestor confirms that the parking asset is occupied by the requestor's vehicle. The confirmation can be through the DPIMS mobile application (e.g., by pressing a virtual button indicating successful completion).

### Example Graphical User Interfaces

FIG. 2A is an example GUI for a mobile device 200 that is provided to a requestor by the DPIMS mobile application, according to an embodiment. The GUI displays a map 205 with marker 201 showing the current location of mobile device 200, marker 202 showing the destination for which parking is desired, markers 203 showing available private parking assets, markers 204 showing available commercial parking assets (e.g., parking structures) and markers 206 showing available flash parking assets. Below the map 205 is a table view with cells for each of the available parking assets within a user specified service area 207. In an embodiment, service area 207 can be defined by a radial distance from the destination represented by marker 202 (e.g., a radial distance of 2 miles). The specified distance can be implemented as a circular geofence around destination marker 202 with a user selectable radius provided, for example, in a settings pane for the DPIMS mobile application (not shown). Each table cell displays a distance to the destination and provides a connect affordance (e.g., a virtual button) for displaying additional information for connecting with the provider, such as a name, phone number, email line, website link and the like. A “more” affordance, when selected by the user, displays/exposes additional providers that did not fit onto the screen. The table cells are divided into three sections: commercial providers, private providers, and flash providers. Each cell also displays the fee for the parking asset. The GUI is used by parking asset requestors 105 to request a parking asset.

Once a parking transaction is confirmed through the mobile application, the mobile application invokes a mapping application and draws a route (not shown) from the current location 201 to the parking asset location and provides turn-by-turn directions to the parking asset location.

FIG. 2B is an example GUI for a mobile device that is provided to a requestor for mobile valet services, according to an embodiment. The GUI shown displays various mobile valet service providers, including their photos, their ratings, fees and an accept/connect affordance for connecting with the mobile valet service provider. The ratings are provided by other requestors and can be any type of rating or scoring system in addition to or in place of to the 5-star rating system shown. The fees can be a standard fee based on time of day, parking fees, toll fees, surge demand or any other formula or fee schedule. In an embodiment, DPIMS can automatically calculate the fees for each mobile valet service provider based on the formula to provide consistency in pricing and prevent gauging.

Referring to the bottom of the GUI, the requestor can specify what they are willing to pay for the service (a “bid”). The requestor can then press the submit/wait affordance, which sends the “bid” to each of the mobile valet service providers that are within service area 207. Upon selection of a service provider by the requestor, the requestor and service provider can agree through any mode of communication (e.g., through the GUI, text messages, email, telephone calls) on the details of the service, such as the drop-off and pick-up locations of the vehicle, time frames, details about a reserved parking asset, etc. When the vehicle is picked-up by the mobile valet service provider, the service provider can drive the vehicle to a nearby parking asset that has been reserved by the requestor or they can use their mobile device to find and reserve a parking asset (e.g., a parking structure, flash parking) using, for example, the GUI shown in FIG. 2A.

If the requestor has reserved the parking asset, then the location of the parking asset and a route to the parking asset will be displayed to the mobile valet service provider upon his/her acceptance of the request. In an embodiment, when a requestor reserves a parking asset in the service area 203 using the GUI of FIG. 2A, DPIMS can automatically provide a list to the requestor's mobile device that includes the available mobile valet service providers in the service area 207, as shown in FIG. 2B. If the mobile valet service provider has to find and reserve a parking asset in the service area, then DPIMS can automatically adjust the total service fee to account for the parking asset fees in addition to the mobile valet service fees. The requestor's account can be billed automatically upon verification that the parking asset was occupied by the requestor's vehicle (e.g. position coordinates, timestamps, digital photo of the vehicle parked in the parking asset, etc.).

FIG. 2C is an example GUI for a mobile device that is provided to a mobile valet service provider, according to an embodiment. The GUI is provided to mobile valet providers and includes a table view of information including a photo of the requestor's car, the distance from the current location of the service provider to the pick-up location, an estimated ETA and a bid if any. Affordances (“Accept” button) for accepting the requests or bids are displayed in the table cell of the corresponding request. The ETA can be calculated automatically based on various information such as travel speed, travel direction and traffic data. If there is a bid, the service provider can select the bid (e.g., a link or button) to open a dialogue that allows the service provider to send a counter bid to the requestor, which is also sent to other service providers in the service area.

An advantage of system 100 is its flexibility for both subscribers and service providers. Subscribers of system 100 can use DPIMS to plan their trip including creating a route from their current location or a departing location to a destination, specify a service area around the destination, reserve a parking asset in the service area and make a reservation with a mobile valet service provider to meet the subscriber at the destination. In the example shown, at destination 202 the mobile valet service provider takes possession of the vehicle and drives the vehicle to a reserved parking space in commercial parking structure 208 located in service area 207. If a parking asset has not been reserved, then the mobile valet service provider can use DPIMS to find a parking asset in service area 207. DPIMS provides a map to the mobile valet service provider including a marker for the parking asset and a route from the service provider's current location to the parking asset.

Mobile valet service providers can use DPIMS to determine locations of high demand for mobile valet services (e.g., near a sporting event, concert, point of interest). If the mobile valet service provider is on foot, he/she can position themselves in a high demand area. For example, “Bob” is a mobile valet service provider. On Saturday morning Bob uses the mobile application to determine the areas of high demand for mobile valet services for Saturday night. For example, an area of high demand can be identified by DPIMS based on a number of reservations for parking assets and mobile valet that have been made. For example, DPIMS can generate and provide a “heat map” through the mobile application that shows areas of high demand according to the service providers specific geographic areas of interest (e.g., San Francisco). Bob can walk, take public transportation or hitch a ride with a friend or carpool with other providers to the area of high demand. In the evening, Bob can use his mobile device to accept requests from subscribers for mobile valet services.

In this example, Bob accepts a request from Alice to meet at a baseball stadium in the city. A week earlier, Alice reserved a parking space in a commercial parking structure located 5 miles from the stadium. Because Alice did not want to walk 5 miles or take public transportation, Alice requested mobile valet drop-off service. Bob meets Alice at the baseball stadium entrance, and after verification that Bob is an authorized mobile valet service provider, Alice allows Bob to take possession of her vehicle. Alice can use her mobile device and the mobile application to track her vehicle to verify that Bob has parked her vehicle at the reserved parking space 5 miles from the baseball stadium.

When Alice is ready to leave the destination, she requests a mobile valet pick-up service using the mobile application for her vehicle to be picked-up and driven to the destination. DPIMS then determines the available mobile valet service providers near the parking structure to pick up Alice's vehicle and drive it back to the baseball stadium. Alice receives a list of service providers who are available to bring her vehicle back to the baseball stadium. Alice selects “Nancy” as her service provider and details about the pick-up location are sent to Nancy. Nancy arrives at the parking structure and claims the keys to Alice's car from the parking attendant. The parking attendant verifies that Nancy is an authorized mobile valet service provider before giving the keys to Nancy. Nancy drives the vehicle back to the baseball stadium. Alice can watch Nancy's progress on a map displayed by the mobile application. Alice and Nancy meet, the keys are exchanged and Alice is on her way back home.

At this end of this fictional DPIMS transaction, Alice has experienced a stress-free night of entertainment because she did not have to hassle with parking. Bob and Nancy receive automatic deposits to their accounts (minus a DPIMS service fee) for their services, Alice's account is automatically debited for the services rendered and the parking structure operator automatically receives their parking fee from DPIMS.

In the above scenario, Bob and Nancy were verified to be authorized mobile valet service providers. There are several ways the verification can be performed. In an embodiment, when Alice meets Bob she can compare Bob's face with his photograph displayed on her mobile device. In addition, Bob can allow Alice to capture his fingerprint on her mobile device, as a secondary verification process. Most modern mobile devices allow a user to access their device through fingerprint authentication. The same fingerprint sensor can be used to authenticate Bob's fingerprint. In other embodiments, other authentication technology can be used such as retinal scans or other biometric methods. The two-step authentication provides robust security. For Bob or Nancy to be authorized, they must submit to DPIMS their fingerprints (and/or retinal scans), photograph, copy of their driver's license and proof of automobile insurance. DPIMS can also perform a background check on each applicant for the mobile valet service, such as criminal background and credit history. In an embodiment, applicants be required to post a bond with DPIMS.

In an embodiment, DPIMS can monitor the route traveled by mobile valet service providers to ensure that a vehicle is not driven outside a specified security zone. For example, DPIMS can automatically track when vehicles using the valet service are driven outside the service area. If the vehicle has a built-in navigation system, DPIMS a receive data from the vehicle navigation system either directly or through another service provider through an Application Programming Interface (APS) provided by DPIMS. In some implementations, the vehicle may have a beacon device which can be programmed to send tracking data to DPIMS or to a third-party tracking service (e.g., the LoJack® service). In some embodiments, the tracking service can use the API to provide tracking data to DPIMS to help track stolen vehicles.

FIG. 2D is an example webpage for a parking asset lessor, according to an embodiment. In an embodiment, registered parking asset owners or operators can access a DPIMS website using a browser to add their parking assets to the DPIMS inventory. In the example GUI shown, a commercial parking asset provider can provide the number of spaces available, hourly rate, available time range, daily rate and available dates. A residential parking asset provider can specify whether asset is a driveway or garage, the number of spaces available, hourly rate, available time range, daily rate and available dates. After submitting this information, DPIMS can add the parking assets to the parking asset inventory. In some embodiments, photos of the parking assets, driving directions to the parking assets and other information can be submitted using the GUI.

FIG. 2E is an example GUI for a mobile device provided to a requestor verifying a flash parking asset through a digital photo, according to an embodiment. In an embodiment, a registered flash parking provider a use the GUI to capture information about a flash parking asset. For example, the user can invoke a camera application to capture a digital photo of a public parking space. The photo with location metadata is sent to DPIMS to be added to the parking asset inventory. A flash parking transaction is successfully completed when a requestor confirms that the parking asset is occupied by the requestor's vehicle. The confirmation can be through the DPIMS mobile application (e.g., by pressing a virtual button indicating successful completion). If the flash parking transaction is successfully completed, the flash provider receives a reward. A reward can be, for example, points that can be redeemed for other items of value (e.g., discounts, coupons). The rewards can be sponsored by enterprises and organizations who provide the awards either directly to the flash providers or through DPIMS.

In an embodiment, the flash provider function can be “gamified” by providing a flash parking application through a mobile app store to flash providers. The flash parking game can encourage competition between flash parking providers by unlocking game assets using points or game currency earned by providing flash parking. For example, a gamer can receive 1 point for every flash parking asset uploaded to DPIMS and 2points for every successfully completed flash parking transaction. The points can then be used to unlock game assets. In an embodiment, any game can be used with the DPIMS flash parking model. For example, in a first-person shooter game or electronic poker game, additional points can be earned by performing a flash parking transaction. In these cases, the game can use a DPIMS supplied API to determine if the flash parking transaction was successfully completed

### Example Processes

FIG. 3 is a flow diagram of a DPIMS process, according to an embodiment. Process 300 can be implemented using, for example, companion device architecture 700 described in reference to FIG. 7.

Process 300 begins by receiving a request or reservation for parking from a requestor (301). Process 300 continues by searching a parking asset inventory for available parking (302). Process 300 continues by sending available parking option(s) to the requestor (306). Process 300 continues by receiving confirmation from the requestor accepting a parking option (308). Process 300 continues by updating the parking asset inventory.

Referring to the previous example, Alice uses the DPIMS mobile application to search for a parking asset in a service area surrounding her destination which is the baseball stadium. Alice receives a list of available parking assets including commercial parking structure 5 miles from the stadium. Alice selects the parking space in the parking structure. DPIMS receives the confirmation from Alice and updates its inventory to indicate that the parking space is reserved. The reservation can be held for a period of time after which the reservation is automatically cancelled. In an embodiment, a cancellation fee can be charged to Alice's account. The cancellation fee can be applied to the account of the parking structure owner or operator.

FIG. 4A is a flow diagram of a DPIMS process 400 for receiving reports from parking asset providers of available parking assets, according to an embodiment. Process 400 can be implemented using, for example, companion device architecture 700 described in reference to FIG. 7.

Process 400 begins by receiving a request to add a parking asset to the parking asset inventory (402). Process 400 continues by updating the parking asset inventory with the added parking asset (404). Process 400 continues by sending a confirmation to the parking asset provider that the parking asset has been added to the parking asset inventory (405).

Referring to the previous example, the owner of the parking structure with the parking space reserved by Alice is Acme Parking Inc. Acme previously registered with DPIMS and has a DPIMS account. An employee of Acme accesses the DPIMS website, selects a tab or page for parking asset providers and adds the parking spaces to the parking inventory, as shown in FIG. 2D. DPIMS adds the parking asset to a database as a commercial parking asset.

FIG. 4B is a flow diagram of a DPIMS process 406 for making payments to parking asset providers upon completion of a parking transaction, according to an embodiment. Process 406 can be implemented using, for example, companion device architecture 700 described in reference to FIG. 7.

Process 406 begins by receiving a confirmation of a completed parking transaction (408) and then initiating a transfer of payment to the parking asset provider (410).

Referring to the previous example, Acme's DPIMS account receives a payment for the parking asset minus a transaction fee for the DPIMS service. Process 406 is also applicable to private parking asset providers.

### Example Database Tables

FIG. 5A illustrates a database table record for hourly parking asset inventory, according to an embodiment. There is an entry or row for each parking asset. Each column represents a field of the parking asset. In this example record, the fields include: location, type, fee, maximum hours/rate, parking asset description, number of assets and account information. Other fields are also possible. Referring to the previous example, Acme has added a parking space at 13:20 of type 1 (commercial space), with a fee of $12/hour, a maximum of 12 hours (no overnight parking) and the parking space is covered.

FIG. 5B illustrates a database table record for scheduled parking asset inventory, according to an embodiment. There is an entry or row for each parking asset location. Each column represents a field of the parking asset. In this example record, the fields include: location, date range reserved, fee, number of spaces, name of lessor and lessor information. Other fields are also possible.

### Example Server Architecture

FIG. 6 is a block diagram of example server architecture for implementing the features and processes described in reference to FIGS. 1-5, according to an embodiment. Other architectures are possible, including architectures with more or fewer components. In some implementations, architecture 600 includes one or more processor(s) 602 (e.g., dual-core Intel® Xeon® Processors), one or more network interface(s) 606, one or more storage device(s) 604 (e.g., hard disk, optical disk, flash memory) and one or more computer-readable medium(s) 608 (e.g., hard disk, optical disk, flash memory, etc.). These components can exchange communications and data over one or more communication channel(s) 610 (e.g., buses), which can utilize various hardware and software for facilitating the transfer of data and control signals between components.

The term “computer-readable medium” refers to any medium that participates in providing instructions to processor(s) 602 for execution, including without limitation, non-volatile media (e.g., optical or magnetic disks), volatile media (e.g., memory) and transmission media. Transmission media includes, without limitation, coaxial cables, copper wire and fiber optics.

Computer-readable medium(s) 608 can further include operating system 612 (e.g., Mac OS® server, Windows® NT server), network communication module 614, remote location-tracking service 616 and other services 618.

Operating system 612 can be multi-user, multiprocessing, multitasking, multithreading, real time, etc. Operating system 612 performs basic tasks, including but not limited to: recognizing input from and providing output to devices 602, 604, 606 and 608; keeping track and managing files and directories on computer-readable medium(s) 608 (e.g., memory or a storage device); controlling peripheral devices; and managing traffic on the one or more communication channel(s) 610. Network communications module 614 includes various components for establishing and maintaining network connections (e.g., software for implementing communication protocols, such as TCP/IP, HTTP, etc.). DPIMS 616 includes software instructions for implementing the server side DPIMS features and processes described in reference to FIGS. 1-5.

Architecture 600 can be included in any computer device, including one or more server computers in a local or distributed network each having one or more processing cores. Architecture 600 can be implemented in a parallel processing or peer-to-peer infrastructure or on a single device with one or more processors. Software can include multiple software components or can be a single body of code.

### Example Electronic Device Architecture

FIG. 7 is a block diagram of example electronic device architecture 700 for implementing the features and processes described in reference to FIGS. 1-5. Architecture 700 may be implemented in any electronic device for generating the features and processes described in reference to FIGS. 1-5, including but not limited to smart phones, tablet computers and wearable computers (e.g., smart watches, fitness bands). Architecture 700 may include memory interface 702, data processor(s), image processor(s) or central processing unit(s) 704, and peripherals interface 706. Memory interface 702, processor(s) 704 or peripherals interface 706 may be separate components or may be integrated in one or more integrated circuits. One or more communication buses or signal lines may couple the various components.

Sensors, devices, and subsystems may be coupled to peripherals interface 706 to facilitate multiple functionalities. For example, motion sensor(s) 710, light sensor 712, and proximity sensor 714 may be coupled to peripherals interface 706 to facilitate orientation, lighting, and proximity functions of the mobile device. For example, in some implementations, light sensor 712 may be utilized to facilitate adjusting the brightness of touch surface 746. In some implementations, motion sensor(s) 710 (e.g., an accelerometer, gyroscope) may be utilized to detect movement and orientation of the device. Accordingly, display objects or media may be presented according to a detected orientation (e.g., portrait or landscape).

Other sensors may also be connected to peripherals interface 706, such as a temperature sensor, a barometer, a biometric sensor 717 or other sensing device, to facilitate related functionalities. For example, a biometric sensor can detect fingerprints and monitor heart rate and other fitness parameters. In an embodiment, a haptic motor (not shown) can be coupled to the peripheral interface, which can provide vibration patterns as haptic feedback.

Location processor 715 (e.g., GNSS receiver chip) may be connected to peripherals interface 706 to provide geo-referencing. Electronic magnetometer 716 (e.g., an integrated circuit chip) may also be connected to peripherals interface 706 to provide data that may be used to determine the direction of magnetic North. Thus, electronic magnetometer 716 may be used as an electronic compass.

Camera subsystem 720 and an optical sensor 722, e.g., a charged coupled device (CCD) or a complementary metal-oxide semiconductor (CMOS) optical sensor, may be utilized to facilitate camera functions, such as recording photographs and video clips.

Communication functions may be facilitated through one or more communication subsystems 724. Communication subsystem(s) 724 may include one or more wireless communication subsystems. Wireless communication subsystems 724 may include radio frequency receivers and transmitters and/or optical (e.g., infrared) receivers and transmitters. Wired communication systems may include a port device, e.g., a Universal Serial Bus (USB) port or some other wired port connection that may be used to establish a wired connection to other computing devices, such as other communication devices, network access devices, a personal computer, a printer, a display screen, or other processing devices capable of receiving or transmitting data.

The specific design and implementation of the communication subsystem 724 may depend on the communication network(s) or medium(s) over which the device is intended to operate. For example, a device may include wireless communication subsystems designed to operate over a global system for mobile communications (GSM) network, a GPRS network, an enhanced data GSM environment (EDGE) network, IEEE802.xx communication networks (e.g., Wi-Fi, Wi-Max, ZigBee™), 3G, 4G, 4G LTE, code division multiple access (CDMA) networks, near field communication (NFC), Wi-Fi Direct and a Bluetooth™ network. Wireless communication subsystems 724 may include hosting protocols such that the device may be configured as a base station for other wireless devices. As another example, the communication subsystems may allow the device to synchronize with a host device using one or more protocols or communication technologies, such as, for example, TCP/IP protocol, HTTP protocol, UDP protocol, ICMP protocol, POP protocol, FTP protocol, IMAP protocol, DCOM protocol, DDE protocol, SOAP protocol, HTTP Live Streaming, MPEG Dash and any other known communication protocol or technology.

Audio subsystem 726 may be coupled to a speaker 728 and one or more microphones 730 to facilitate voice-enabled functions, such as voice recognition, voice replication, digital recording, telephony functions and for receiving sound signals from an accessory device, as described in reference to FIGS. 1-5.

I/O subsystem 740 may include touch controller 742 and/or another input controller(s) 744. Touch controller 742 may be coupled to a touch surface 746. Touch surface 746 and touch controller 742 may, for example, detect contact and movement or break thereof using any of a number of touch sensitivity technologies, including but not limited to, capacitive, resistive, infrared, and surface acoustic wave technologies, as well as other proximity sensor arrays or other elements for determining one or more points of contact with touch surface 746. In one implementation, touch surface 746 may display virtual or soft buttons and a virtual keyboard, which may be used as an input/output device by the user.

Other input controller(s) 744 may be coupled to other input/control devices 748, such as one or more buttons, rocker switches, thumb-wheel, infrared port, USB port, and/or a pointer device such as a stylus. The one or more buttons (not shown) may include an up/down button for volume control of speaker 728 and/or microphone 730.

In some implementations, device 700 may present recorded audio and/or video files, such as MP3, AAC, and MPEG video files. In some implementations, device 700 may include the functionality of an MP3 player and may include a pin connector for tethering to other devices. Other input/output and control devices may be used. In an embodiment, device 700 may include an audio processing unit for streaming audio to an accessory device over a direct or indirect communication link, as described in reference to FIGS. 1-10.

Memory interface 702 may be coupled to memory 750. Memory 750 may include high-speed random-access memory or non-volatile memory, such as one or more magnetic disk storage devices, one or more optical storage devices, or flash memory (e.g., NAND, NOR). Memory 750 may store operating system 752, such as Darwin, RTXC, LINUX, UNIX, OS X, iOS, WINDOWS, or an embedded operating system such as VxWorks. Operating system 752 may include instructions for handling basic system services and for performing hardware dependent tasks. In some implementations, operating system 752 may include a kernel (e.g., UNIX kernel).

Memory 750 may also store communication instructions 754 to facilitate communicating with one or more additional devices, one or more computers or servers, including peer-to-peer communications with wireless accessory devices, as described in reference to FIGS. 1-5. Communication instructions 754 may also be used to select an operational mode or communication medium for use by the device, based on a geographic location (obtained by the GPS/Navigation instructions 768) of the device.

Memory 750 may include graphical user interface instructions 756 to facilitate graphic user interface processing, including a touch model for interpreting touch inputs and gestures; sensor processing instructions 758 to facilitate sensor-related processing and functions; phone instructions 760 to facilitate phone-related processes and functions; electronic messaging instructions 762 to facilitate electronic-messaging related processes and functions; web browsing instructions 764 to facilitate web browsing-related processes and functions; media processing instructions 766 to facilitate media processing-related processes and functions; GPS/Navigation instructions 768 to facilitate GPS and navigation-related processes; camera instructions 770 to facilitate camera-related processes and functions; and parking management application instructions 772 for implementing client-side processes described in reference to FIGS. 1-5. The GPS/Navigation instructions 768 include instructions for estimating location, including but not limited to an extended Kalman filter and other processes for estimating location.

Each of the above identified instructions and applications may correspond to a set of instructions for performing one or more functions described above. These instructions need not be implemented as separate software programs, procedures, or modules. Memory 750 may include additional instructions or fewer instructions. Furthermore, various functions of the device may be implemented in hardware and/or in software, including in one or more signal processing and/or application specific integrated circuits (ASICs).

The features described may be implemented in digital electronic circuitry or in computer hardware, firmware, software, or in combinations of them. The features may be implemented in a computer program product tangibly embodied in an information carrier, e.g., in a machine-readable storage device, for execution by a programmable processor; and method steps may be performed by a programmable processor executing a program of instructions to perform functions of the described implementations by operating on input data and generating output.

The described features may be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that may be used, directly or indirectly, in a computer to perform a certain activity or bring about a certain result. A computer program may be written in any form of programming language (e.g., Objective-C, Java), including compiled or interpreted languages, and it may be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors or cores, of any kind of computer. Generally, a processor will receive instructions and data from a read-only memory or a random-access memory or both. The essential elements of a computer are a processor for executing instructions and one or more memories for storing instructions and data. Generally, a computer may communicate with mass storage devices for storing data files. These mass storage devices may include magnetic disks, such as internal hard disks and removable disks; magneto-optical disks; and optical disks. Storage devices suitable for tangibly embodying computer program instructions and data include all forms of non-volatile memory, including by way of example, semiconductor memory devices, such as EPROM, EEPROM, and flash memory devices; magnetic disks such as internal hard disks and removable disks; magneto-optical disks; and CD-ROM and DVD-ROM disks. The processor and the memory may be supplemented by, or incorporated in, ASICs (application-specific integrated circuits). To provide for interaction with a user the features may be implemented on a computer having a display device such as a CRT (cathode ray tube), LED (light emitting diode) or LCD (liquid crystal display) display or monitor for displaying information to the author, a keyboard and a pointing device, such as a mouse or a trackball by which the author may provide input to the computer.

One or more features or steps of the disclosed embodiments may be implemented using an Application Programming Interface (API). An API may define on or more parameters that are passed between a calling application and other software code (e.g., an operating system, library routine, function) that provides a service, that provides data, or that performs an operation or a computation. The API may be implemented as one or more calls in program code that send or receive one or more parameters through a parameter list or other structure based on a call convention defined in an API specification document. A parameter may be a constant, a key, a data structure, an object, an object class, a variable, a data type, a pointer, an array, a list, or another call. API calls and parameters may be implemented in any programming language. The programming language may define the vocabulary and calling convention that a programmer will employ to access functions supporting the API. In some implementations, an API call may report to an application the capabilities of a device running the application, such as input capability, output capability, processing capability, power capability, communications capability, etc.

A number of implementations have been described. Nevertheless, it will be understood that various modifications may be made. Elements of one or more implementations may be combined, deleted, modified, or supplemented to form further implementations. In yet another example, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other implementations are within the scope of the following claims.

What is claimed is:

1. A method comprising:
receiving, by one or more processors of a dynamic parking information management system, a first request for a parking asset, the first request including a destination location and reservation data;
searching, by the one or more processors, a parking asset inventory database for one or more parking assets within a service area that includes the destination location;
receiving, by the one or more processors, a selection of a parking asset in the service area;
reserving, by the one or more processors, the selected parking asset according to the reservation data;
receiving, by the one or more processors, a second request for mobile valet service in the service area;
determining, by the one or more processors, one or more mobile valet service providers within the service area that are available to provide the mobile valet service;
receiving, by the one or more processors, a selection of a mobile valet service provider in the service area;
verifying, by the one or more processors, that a vehicle was parked in the selected parking asset according to the reservation data;
determining, by the one or more processors, one or more electronic payments to a first online account of the selected mobile valet service provider;
determining, by the one or more processors, one or more electronic payments to a second online account of an owner or operator of the selected parking asset; and
determining, by the one or more processors, one or more electronic debits to a third online account for fees associated with reserving the parking asset and receiving the mobile valet service.

2. The method of claim 1, wherein the parking asset inventory includes private parking assets, commercial parking assets and flash parking assets.

3. The method of claim 2, where the selected parking asset is a private parking asset that includes one of a homeowner's garage, driveway or yard.

4. The method of claim 2, wherein the selected parking asset is a flash parking asset provided by a user through a game reward system.

5. The method of claim 1, wherein the first request is received by the selected mobile valet service provider after the second request.

6. The method of claim 1, further comprising:
receiving, by the one or more processors, biometric data for the selected mobile valet service provider; and
authenticating, by the one or more processors, the identity of the selected mobile valet service provider based at least in part on the biometric data.

7. The method of claim 1, further comprising:
determining, by the one or more processors, a route between a current location of the mobile valet service provider and the selected parking asset; and
sending, by the one or more processors, map data including the route to a mobile device used by the selected mobile valet service provider while providing the mobile valet service.

8. The method of claim 1, further comprising:
receiving, by the one or more processors, flash parking asset information including a digital photo and location of a flash parking asset, and a timestamp indicating a current time;
receiving, by the one or more processors, confirmation data indicating that the flash parking asset was occupied by the vehicle; and
responsive to the confirmation data, determining, by the one or more processors, one or more electronic payments to the third online account for the flash parking asset.

9. A dynamic parking information management system, comprising:
one or more processors;
memory storing instructions that when executed by the one or more processors, cause the one or more processors to perform operations comprising:
receiving, by one or more processors of a dynamic parking information management system, a first request for a parking asset, the first request including a destination location and reservation data;
searching, by the one or more processors, a parking asset inventory database for one or more parking assets within a service area that includes the destination location;
receiving, by the one or more processors, a selection of a parking asset in the service area;
reserving, by the one or more processors, the selected parking asset according to the reservation data;
receiving, by the one or more processors, a second request for mobile valet service in the service area;
determining, by the one or more processors, one or more mobile valet service providers within the service area that are available to provide the mobile valet service;
receiving, by the one or more processors, a selection of a mobile valet service provider in the service area;
verifying, by the one or more processors, that a vehicle was parked in the selected parking asset according to the reservation data;
determining, by the one or more processors, one or more electronic payments to a first online account of the selected mobile valet service provider;
determining, by the one or more processors, one or more electronic payments to a second online account of an owner or operator of the selected parking asset; and
determining, by the one or more processors, one or more electronic debits to a third online account for fees associated with reserving the parking asset and receiving the mobile valet service.

10. The system of claim 9, wherein the parking asset inventory includes private parking assets, commercial parking assets and flash parking assets.

11. The system of claim 10, where the selected parking asset is a private parking asset that includes one of a homeowner's garage, driveway or yard.

12. The system of claim 10, wherein the selected parking asset is a flash parking asset provided by a user through a game reward system.

13. The system of claim 9, wherein the first request is received by the selected mobile valet service provider after the second request.

14. The system of claim 9, further comprising:
receiving, by the one or more processors, biometric data for the selected mobile valet service provider; and
authenticating, by the one or more processors, the identity of the selected mobile valet service provider based at least in part on the biometric data.

15. The system of claim 9, further comprising:
determining, by the one or more processors, a route between a current location of the mobile valet service provider and the selected parking asset; and
sending, by the one or more processors, map data including the route to a mobile device used by the selected mobile valet service provider while providing the mobile valet service.

16. The system of claim 9, further comprising:
receiving, by the one or more processors, flash parking asset information including a digital photo and location of a flash parking asset, and a timestamp indicating a current time;
receiving, by the one or more processors, confirmation data indicating that the flash parking asset was occupied by the vehicle; and
responsive to the confirmation data, determining, by the one or more processors, one or more electronic payments to the third online account for the flash parking asset.

17. A method comprising:
receiving, by one or more processors of a mobile device, a first user input for requesting reservation of a parking asset, the first user input including a destination location and reservation data;
sending, by the one or more processors, a first request including the first user input to a dynamic parking information management system;
receiving, by the one or more processors and from the dynamic parking information management system, one or more parking assets located in a service area that includes the destination location;
receiving, by one or more processors of a mobile device, a second user input selecting a parking asset;
sending, by the one or more processors, a second request including the second user input to a dynamic parking information management system;
receiving, by the one or more processors, confirmation from the dynamic parking information system that the selected parking asset is reserved according to the reservation data;
receiving, by the one or more processors, a third user input, the third user input including a request for a mobile valet service;
receiving, by the one or more processors and from the dynamic parking information management system, one or more mobile valet service located in the service area;
receiving, by the one or more processors, a fourth user input selecting a mobile service provider;
sending, by the one or more processors, a third request including the third user input to a dynamic parking information management system; and
receiving, by the one or more processors, confirmation from the dynamic parking information system that the selected mobile valet service provider will provide the mobile valet service at the destination.

18. The method of claim 17, further comprising:
receiving, by the one or more processors, biometric data for the selected mobile valet service provider; and
sending, by the one or more processors, the biometric data to the dynamic parking information management system to authenticate the selected mobile valet service provider's identity.

19. The method of claim 17, comprising:
determining, by the one or more processors, a route between a current location of the mobile valet service provider and the selected parking asset; and
sending, by the one or more processors, map data including the route to the mobile device during the mobile valet service.

20. A non-transitory, computer-readable storage medium having instructions stored thereon, that when executed by one or more processors, cause the one or more processors to perform operations comprising:
receiving, by one or more processors of a dynamic parking information management system, a first request for a parking asset, the first request including a destination location and reservation data;
searching, by the one or more processors, a parking asset inventory database for one or more parking assets within a service area that includes the destination location;
receiving, by the one or more processors, a selection of a parking asset in the service area;
reserving, by the one or more processors, the selected parking asset according to the reservation data;
receiving, by the one or more processors, a second request for mobile valet service in the service area;
determining, by the one or more processors, one or more mobile valet service providers within the service area that are available to provide the mobile valet service;
receiving, by the one or more processors, a selection of a mobile valet service provider in the service area;
verifying, by the one or more processors, that a vehicle was parked in the selected parking asset according to the reservation data;
determining, by the one or more processors, one or more electronic payments to a first online account of the selected mobile valet service provider;
determining, by the one or more processors, one or more electronic payments to a second online account of an owner or operator of the selected parking asset; and
determining, by the one or more processors, one or more electronic debits to a third online account for fees associated with reserving the parking asset and receiving the mobile valet service.
